(19) United States
(12) Patent Application Publication
(10) Pub. No.: US 2018/0350252 A1
(43) Pub. Date: Dec. 6, 2018

(54) Learning Program Provision System and Learning Program Provision Method

(71) Applicant: Hitachi, Ltd., Chiyoda-ku, Tokyo (JP)

(72) Inventors: Hidekatsu TAKADA, Tokyo (JP); Hideyuki BAN, Tokyo (JP)

(21) Appl. No.: 15/761,638

(22) PCT Filed: Jun. 3, 2016
(86) PCT No.: PCT/JP2016/066567

§ 371 Date: Mar. 20, 2018

(51) Int. Cl. G09B 7/02; G09B 19/00

(52) U.S. Cl. CPC G09B 7/02; G09B 19/025; G09B 19/00

(57) ABSTRACT

A learning program provision system obtains learning history corresponding to each of a plurality of units shown by learning history information, compares the obtained learning history regarding each of the plurality of units and a condition based on at least one of an understanding level and an activity achievement regarding each of the plurality of units with each other, and obtains instruction guidelines corresponding to satisfied conditions from the instruction guideline information; outputs the obtained instruction guidelines to a student terminal used by the student; compares the obtained learning history and a condition based on at least one of the understanding level and the activity achievement with each other, and obtains intervention guidelines corresponding to satisfied conditions from the intervention information; and outputs the obtained intervention guidelines to the student terminal used by the student.

### TECHNICAL FIELD

The present invention relates to a learning program provision system and a learning program provision method.

### BACKGROUND ART

In correspondence education, students receive educational materials from an instructor (a correspondence education service provider), and usually the students execute self-learning mainly at home using the educational materials. The instructor checks the understanding levels of the students in accordance with the progresses of lessons, and gives instructions to the students with making appropriate comments and the like. In the case where students are youngsters (high school students or younger ones), the contractors of the correspondence education service for the students are often the guardians of the students.

As one of the background technologies of this technological field, there is a technology disclosed in Japanese Unexamined Patent Application Publication No. 2004-62071 (Patent Literature 1). This patent application publication describes the following: A management center 1, each of schools 2, the computers of students 4, and the mobile terminals of the parents 5 of the students 4 are connected to a computer network WEB. The management center 1 is a server for each of the school 2, and provides a server to each of the schools. Each of the schools 2 is a user of the management center 1, and provides educational service to the students 4 using the server provided from the management center 1. The students 4 receive learning backup from each of the schools 2; the parents 5 of the students participate in the learning of the students 4 as the clients of each of the school 2; the management center 1 executes access rights to each of the schools 2, to which the students belong, and to the class instructors 3 of each of the schools; and the management center 1, each of the schools 2, and the parents 5 of the students provide education for the students and manage the students in concerted efforts (refer to Abstract).

### CITATION LIST

### Patent Literature

### Patent Literature 1: Japanese Unexamined Patent Application Publication No. 2004-62071

### SUMMARY OF INVENTION

### Technical Problem

Especially in correspondence education for children, it is often difficult for the children to work at their learning independently and continuously for the reason that they get tired of their self-learning or the like. It often happens that the motivation for self-learning of children is sustained or improved not only due to direct instructions executed by instructors but also due to daily encouragements through interventions executed by guardians. Nevertheless, Patent Literature 1 does not describe a technology with the use of which the cooperation of the instructions of the instructors and the interventions of the guardians is supported.

An object of an aspect of the present invention is to provide information for sustaining or improving the motivation for the self-learning of a student in accordance with the learning history of the student in order to solve the abovementioned problem.

### Solution to Problem

In order to solve the above problem, an aspect of the present invention adopts the following configuration. The aspect of the present invention assumes the form of a learning program provision system for providing a student with a learning program including a plurality of units. The learning program provision system includes a processor and a storage device. The storage device stores learning history information that shows a learning history including at least one of an understanding level and an activity achievement for each of the plural units of the student; instruction guideline information that shows the relationship between a condition based on at least one of the understanding level and the activity achievement and an instruction guideline including guidelines for instructions executed to the student by an instructor in charge of the learning program; and intervention guideline information that shows the relationship between a condition based on at least one of the understanding level and the activity achievement and an intervention guideline including guidelines for interventions executed to the student by a supporter who supports the learning of the student and who is not the instructor, and the processor obtains a learning history corresponding to each of the plural units shown by the learning history information; compares the obtained learning history regarding each of the plurality of units and a condition regarding each of the plural units shown by the instruction guideline information with each other, and obtains instruction guidelines corresponding to satisfied conditions from the instruction guideline information; outputs the obtained instruction guidelines to a student terminal used by the student; compares the obtained learning history regarding each of the plural units and a condition regarding each of the plural units shown by the intervention guideline information with each other, and obtains intervention guidelines corresponding to satisfied conditions from the intervention guideline information; and outputs the obtained intervention guidelines to the student terminal used by the student.

### Advantageous Effects of Invention

According to an aspect of the present invention, information for sustaining or improving the motivation for self-learning of a student in accordance with his/her learning history can be proposed.

### BRIEF DESCRIPTION OF DRAWINGS

FIG. 1 is a block diagram showing a configuration example of a learning program provision system according to a first embodiment.

FIG. 2 shows an example of a contract information table according to the first embodiment.

FIG. 3 shows an example of an educational material information table according to the first embodiment.

FIG. 4 shows an example of a learning history table according to the first embodiment.

FIG. 5 shows an example of an instruction/intervention guideline table according to the first embodiment.

FIG. 6 shows an example of an instruction history table according to the first embodiment.

FIG. 7 shows an example of an intervention request history table according to the first embodiment.

FIG. 8 is a flowchart showing an example of instruction information creation processing and intervention request information creation processing according to the first embodiment.

FIG. 9 shows an example of an instructor screen displayed on an instructor terminal according to the first embodiment.

FIG. 10 shows an example of a supporter screen displayed on a supporter terminal according to the first embodiment.

### DESCRIPTION OF EMBODIMENTS

Hereinafter, an embodiment of the present invention will be explained with reference to the accompanying drawings. It should be noted that this embodiment is only an example for realizing the present invention, and does not limit the technological scope of the present invention. Common configurations in the accompanying drawings are given the same reference signs.

### First Embodiment

In this embodiment, it will be assumed that there exist an “instructor” who instructs a “student”, who receives a learning program, in a position to be a learning program provider and a “supporter” who supports the learning of the student in a position to be closer to the student and not to be a learning program provider. In the case of a learning program used in a correspondence education service where a child is an object person, the child is a student, a teacher (or a lecturer) belonging to the correspondence education service company is an instructor, and the guardian of the child is a supporter. Here, it will be assumed that the learning program includes comments used for the student to understand the contents of the learning by the student's reading or hearing them, and questions used for measuring the understanding level of the contents of the learning of the student.

Instructions include words and actions made by the instructor to the student for directly contributing to the improvement of the understanding level of the student regarding the units of an educational material. The units of an educational material are the constitutional courses of learning contents included in the aforementioned educational material. In the case where there is a down point in the answer of the student to a question owing to the carelessness of the student, an indication made by the instructor regarding the careless mistake made by the student is an example of an instruction.

Interventions include words and actions made by a third person (the supporter in this embodiment) other than the instructor to the student for contributing to the sustainment of the motivation and the improvement of the activity of the student regarding the learning program. In addition, the interventions can include words and actions made by the aforementioned third person to the student for directly or indirectly contributing to the improvement of the understanding level of the student regarding the units of an educational material. In the case where the student continues referring to comments a predefined time or longer without interruptions, a praise given to the student by the supporter for his/her concentration into learning is an example of an intervention.

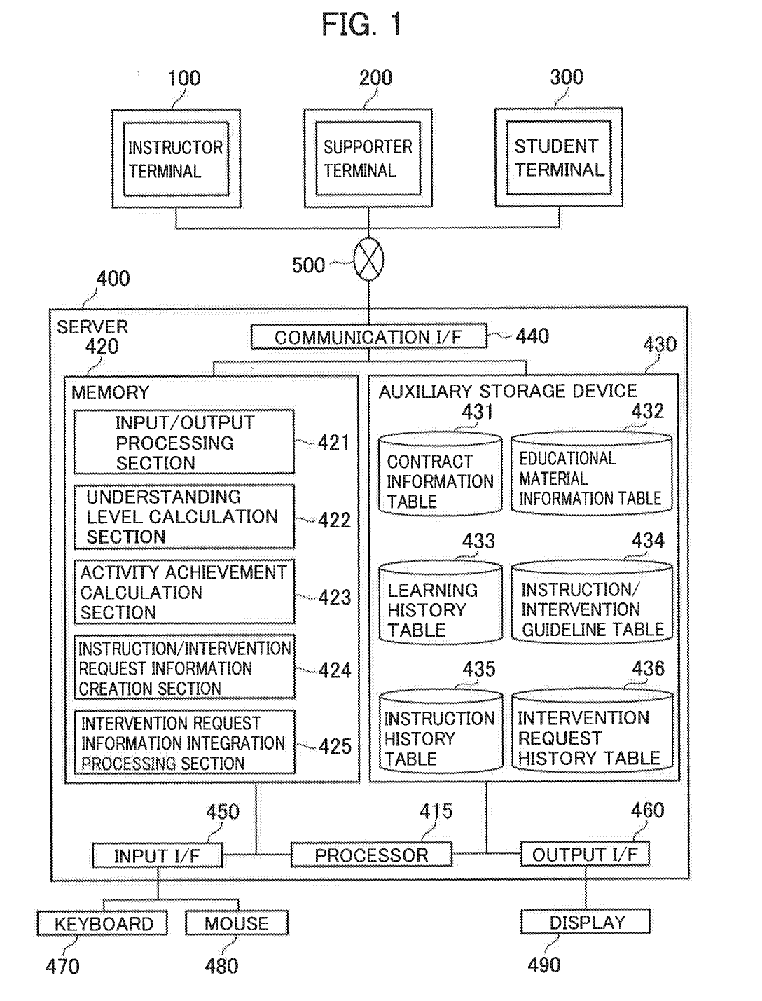

FIG. 1 is a block diagram showing a configuration example of a learning program provision system according to this embodiment. The learning program provision system includes, for example, an instructor terminal 100, a supporter terminal 200, a student terminal 300, and a server 400. The instructor terminal 100, the supporter terminal 200, the student terminal 300, and the server 400 are connected to each other via a network 500 such as the Internet.

Each of the instructor terminal 100, the supporter terminal 200, and the student terminal 300 includes, for example, a computer including a processor, a memory, a communication interface, an auxiliary storage device; and an input/output interface. Alternatively, each of the instructor terminal 100, the supporter terminal 200, and the student terminal 300 can be any of a tablet computer, a smart phone, and a mobile phone on which an application program (for example, a web browser) is running. Furthermore, both supporter terminal 200 and student terminal 300 can be realized by one terminal.

The server 400 includes, for example, a computer including a processor 415, a memory 420, an auxiliary storage device 430, and a communication interface 440.

The processor 415 executes programs stored in the memory 420. The memory 420 includes a ROM that is a nonvolatile memory element ROM, and a RAM that is a volatile memory. The ROM stores an invariable program (for example, a BIOS) and the like. The RAM is a high-speed and volatile storage element such as a DRAM (a dynamic random access memory), and temporarily stores programs executed by the processor 415 and data that is used in the execution of the programs.

The auxiliary storage device 430 is a high-capacity and nonvolatile storage device such as a magnetic storage device (HDD) a flash memory (SSD), or the like, and stores programs executed by the processor 415 and the data that is used in the execution of the program. In the other words, the programs are read out from the auxiliary storage device 430, loaded into the memory 420, and executed by the processor 415.

The server 400 can include an input interface 450 and an output interface 460. The input interface 450 is connected to a keyboard 470, a mouse 480, and the like, and it is an interface for receiving inputs from an operator. The output interface 460 is connected to a display device 490, a printer, and the like, and it is an interface for outputting the results of the execution of the programs in such a way that an operator can visually recognize the results.

The communication interface 440 is a network interface device for controlling communications with other devices in accordance with a predefined protocol. In addition, the communication interface 440 includes, for example, a serial interface such as a USB.

The programs executed by the processor 415 are provided to the server 400 via a removable medium (a CD-ROM, a flash memory, or the like) or via a network, and stored in the nonvolatile auxiliary storage device 430 that is a non-temporary storage device. Therefore, it is conceivable that the server 400 includes an interface for reading data from a removable medium.

It is conceivable that the server 400 is a computer system that is set up physically on one computer, or set up on plural computers that are logically or physically combined with each other, and in some case the server 400 runs on the separated threads of one computer, and in other cases the server 400 runs on virtual computers set up on plural physical computer resources.

The memory 420 includes, for example, an input/output processing section 421, an understanding level calculation section 422, an activity achievement calculation section 423, an instruction/intervention request information creation section 424, and an intervention request information integration processing section 425, where all the abovementioned sections are realized by programs. For example, the processor 415 functions as an input/output processing section through its behavior in accordance with the input/output processing section 421 (a kind of program) loaded in the memory 420, and functions as an understanding level calculation section through its behavior in accordance with the understanding level calculation section 422 (a kind of program) loaded in the memory 420. As for other sections stored in the memory 420, the processor 415 functions in similar ways as mentioned above.

The input/output processing section 421 obtains inputs from the communication interface 440 and the input interface 450, and transfers these inputs to other processing sections. Furthermore, the input/output processing section 421 obtains outputs from other processing sections, and transfers these outputs to the communication interface 440 and the input interface 450.

The understanding level calculation section 422 calculates the understanding level of a student regarding the learning program. The activity achievement calculation section 423 calculates the activity achievement of the student regarding the learning program. The instruction/intervention request information creation section 424 creates instruction information and intervention request information using at least one of the understanding level and the activity achievement of the student regarding the learning program. The intervention request information integration processing section 425 integrates plural intervention requests for the same student.

The auxiliary storage device 430 includes, for example, a contract information table 431, an instruction information table 432, a learning history table 433, an instruction/intervention guideline table 434, an instruction history table 435, and an intervention request history table 436.

In addition, although the case where pieces of information are stored in the tables will be explained in this embodiment, information used in the system in this embodiment can be represented in an arbitrary data structure, that is, can be represented independently of a data structure to be used for representing the information. For example, the information can be stored in a data structure appropriately selected from a table, a list, a database, and a queue. Pieces of information used by an information storage system are respectively stored in the corresponding data storage areas of a data storage device.

The contract information table 431 stores the contract information of learning programs. The educational material information table 432 stores the information of educational materials used for learning programs. The learning history table 433 stores the history information of learnings that have been executed by students who are participating learning programs. The instruction/intervention guideline table 434 stores information showing instruction guidelines to students and intervention request guidelines to the students.

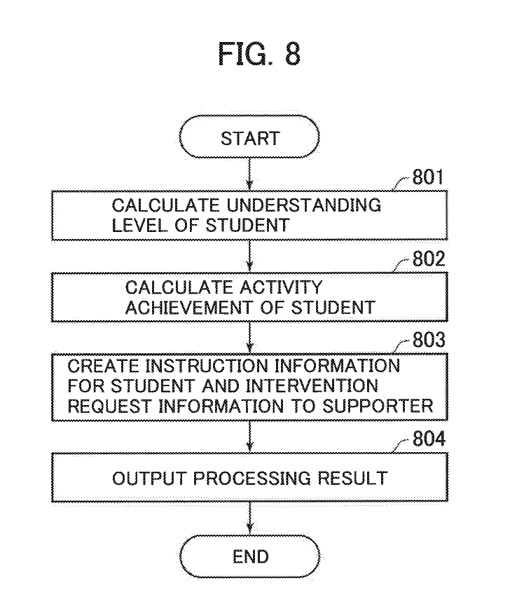

The instruction history table 435 stores information showing instruction histories regarding instructions that have been made to students by instructors. The intervention request history table 436 stores information showing intervention request histories regarding intervention requests that have been made to supporters by instructors. The information regarding instruction history table 435 and the information regarding the intervention request history table 436 are created through processing shown in FIG. 8, and plural pieces of information regarding other tables are created in advance before the processing shown in FIG. 8.

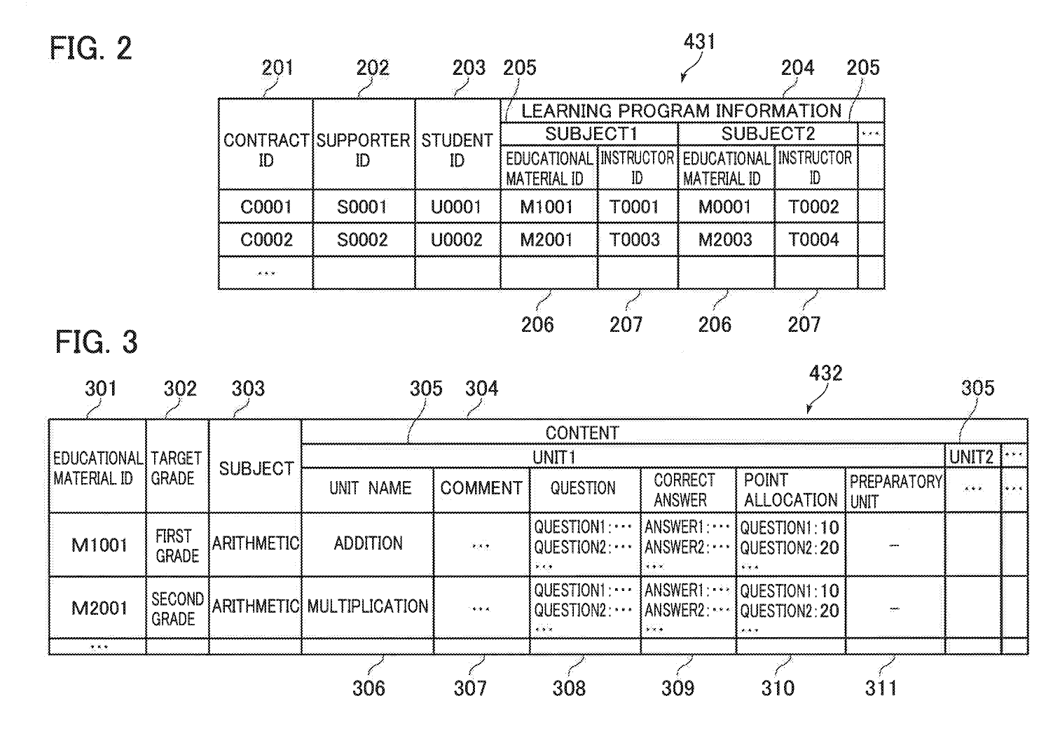

FIG. 2 shows an example of the contract information table 431. The contract information table 431 includes, for example, a contract ID column 201, a supporter ID column 202, a student ID column 203, and a learning program information column 204. The contract ID column 201 stores contract IDs for identifying contracts. The supporter ID column 202 stores supporter IDs for identifying supporters. Here, if there are contractors who are not supporters, the contract information table can further include contractor IDs for identifying the aforementioned contractors. The student ID column 203 stores student IDs for identifying students.

The learning program information column 204 includes, for example, one or more subject columns 205. Each of the subject columns 205 includes, for example, an educational material ID column 206 that stores educational material IDs for identifying the educational materials of the corresponding subjects, and an instructor ID column 207 that stores instructor IDs for identifying the instructors of the corresponding subjects. Furthermore, it is conceivable that plural educational materials IDs are stored in one cell of a subject column 205, and it is also conceivable that instructor IDs that are respectively corresponding to the aforementioned plural educational material IDs are stored in a cell of an instructor ID column 207 adjacent to the aforementioned cell.

FIG. 3 shows an example of the educational material information table 432. The educational material information table 432 includes, for example, an educational material ID column 301, a target grade column 302, a subject column 303, and a content column 304. The educational material ID column 301 stores educational material IDs. The target grade column 302 stores information showing grades that are respectively the targets of the corresponding educational materials. The subject column 303 stores information showing the subjects of the corresponding educational materials.

The content column 304 stores information showing the contents of the corresponding educational materials, and includes one or more unit columns 305. A unit is a course including a bundle of learning contents regarding a certain theme. Each of the unit columns 305 includes, for example, a unit name column 306, a comment column 307, a question column 308, a correct answer column 309, a point allocation column 310, and a preparatory unit column 311. The unit name column 306 stores the names of the corresponding units. The comment column 307 stores comments regarding the corresponding units.

The question column 308 stores one or more questions regarding each of the corresponding units. In addition, each question column 308 can further store information showing questions that are stored in the aforementioned question column and become prior conditions for solving other questions stored in the aforementioned question column. Hereinafter, a question that becomes a prior question for solving another question will be referred to as a preparatory question of the latter question. For example, if there are a question 1 that is a question regarding making a mathematical expression and a question 2 that is a question regarding deriving a final answer using the aforementioned mathematical expression, the question 1 is a preparatory question for the question 2. Here, for example, in the case where N and M are arbitrary natural numbers and N<M, it can be said that a question N is a preparatory question for a question M.

The correct answer column 309 stores correct answers to the respective questions of the corresponding question column 308. The point allocation column 310 stores allocated points for the respective questions of the corresponding question column 308.

The preparatory unit column 311 stores information showing one or more preparatory units regarding each of the corresponding units. A preparatory unit is a unit in which prior knowledge for learning a certain unit, and for example, a unit “addition” is a preparatory unit for a unit “subtraction”. If there is a preparatory unit for a certain unit, it is desirable that a student should learn the aforementioned certain unit after he/she learns the aforementioned preparatory unit. Here, it is conceivable that the preparatory unit column 311 also stores index values showing the strengths of the associations between the corresponding units and their respective preparatory units. Furthermore, preparatory units shown by the preparatory column 311 can be units belonging to different educational material IDs.

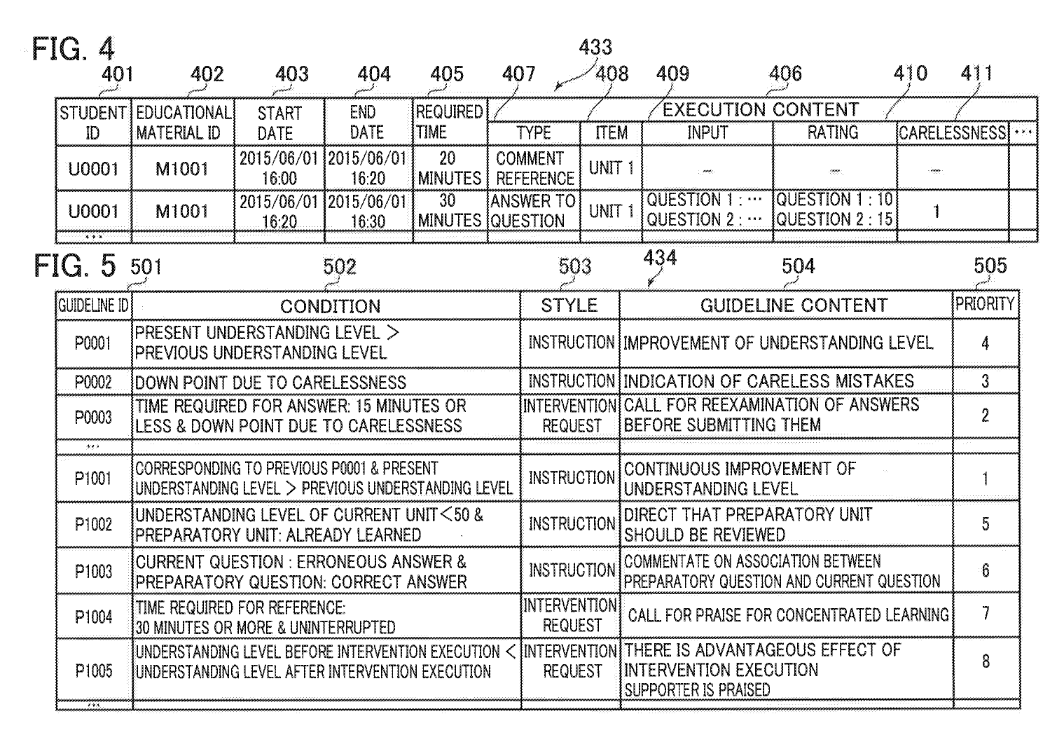

FIG. 4 shows an example of the learning history table 433. The learning history table 433 includes, for example, a student ID column 401, an educational material column 402, a start date column 403, an end date column 404, a required time column 405, and an execution content column 406.

The student ID 401 stores student IDs. The educational material ID 402 stores educational material IDs. The start date column 403 stores the start dates of learnings shown by the corresponding execution contents. The end date column 404 stores the end times of learnings shown by the corresponding execution contents.

The required time column 405 shows the required times of learnings shown by the corresponding execution contents. Here, because there is a possibility that a student interrupts his/her learning and restarts it again, a required time is not always equal to the difference between the relevant start date and the relevant end date. In addition, if a student has not finished the learning of the corresponding learning content yet, null values are stored in the end date column 404 and the required time column 405.

The execution content column 406 includes, for example, a type column 407, an item column 408, an input column 409, a rating column 410, and a carelessness flag column 411. The type column 407 stores the types of executed learning contents, for example, the values of “comment reference” and “answer to question”, and the like. The item column 408 stores information showing units in the corresponding educational materials of executed learnings.

The input column 409 stores information showing input contents from students in executed learnings. The rating column 410 stores information showing the rating results of answers to the respective questions shown in the input column 409 corresponding to records each having “answer to question” as the value of the type column 407.

The carelessness flag column 411 stores flags indicating whether there are down points due to carelessness in rating results shown by the rating column 410 corresponding to the records each having “answer to question” as the value of the type column 407 or not. For example, if a record does not include a down point due to carelessness, the corresponding carelessness flag is “0”, and if a record includes a down point due to carelessness, the corresponding carelessness flag is “1”. Here, it is conceivable that the carelessness flag column 411 stores carelessness flags corresponding to the respective rating results shown by the rating column 410. Furthermore, for example, null values are input in the input column 409, the rating column 410, and the carelessness flag column 411 of a record the type of which is “comment reference”.

In the example shown in FIG. 4, the fact that a student with a student ID “U0001” answered questions “question 1” and “question 2” after he/she used an educational material ID “M1001” and referred to the comment of “unit 1”, and the rating results were “10” and “15” respectively is recorded in the learning history table 433.

Here, for example, as for the rating result column 410, it is also conceivable that, after referring to a value of the input column 409 and the correct answer column 309 regarding a question corresponding to the aforementioned value of the educational material information table 432, the understanding level calculation section 422 automatically calculates a rating result and stores the calculated rating result in the rating column 410.

In addition, for example, if there is carelessness that the numeric value of a student's answer to a question of the unit of arithmetic is correct but the answer is lacking in a unit or the like, it is conceivable that the understanding level calculation section 422 stores a calculation result from which a predefined down point has already been subtracted in the rating column 410, and stores the carelessness flag “1” in the carelessness flag column 411. Here, it will be assumed that answers that are targets of the deduction of points due to students' carelessness for each question and the ranges of the down points are predefined.

Alternatively, it is also conceivable that the input/output processing section 421 obtains a rating result that includes a carelessness flag and that is received from the instructor terminal 100, and stores the obtained rating result in the rating column 410 and the carelessness flag column 411.

FIG. 5 shows an example of the instruction/intervention table 434. The instruction/intervention guideline table 434 includes, for example, a guideline ID column 501, a condition column 502, a style column 503, a guideline content column 504, and a priority column 505. The guideline ID column 501 includes index IDs that are used for identifying guidelines. The condition column 502 stores conditions used for judging whether the corresponding guidelines are satisfied or not.

The respective conditions stored in the condition column 502 are represented, for example, by combinations of the logical multiplication or logical addition of conditions regarding the understanding levels of students of the respective units (to be described later), conditions regarding the activity achievements of the students (to be described later), and/or conditions shown by the respective tables. The style column 503 shows whether the corresponding guidelines are instruction guidelines or intervention request guidelines.

The guideline content column 504 of a record, the value of the style column 503 corresponding to which is “instruction”, stores the content of an instruction guideline, and the guideline content column 504, the value of the style column 503 corresponding to which is “intervention request”, stores the content of an intervention request guideline. In the case where plural conditions in the condition column 502 are satisfied, the priority column 505 stores the priority of the proposed guideline. Here, the conditions in an example shown in FIG. 5 are examples, therefore a manager of the learning management system or the like can executes the modification, deletion, addition, and the like of the conditions.

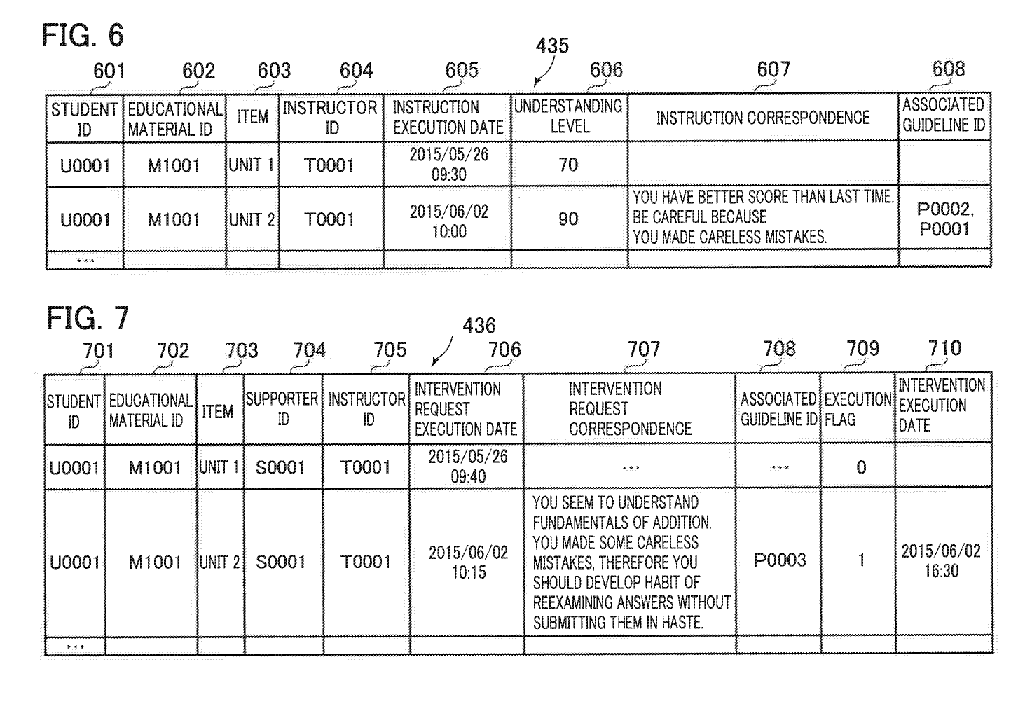

FIG. 6 shows an example of the instruction history table 435. The instruction history table 435 includes, for example, a student ID column 601, an educational material ID column 602, an item column 603, an instructor ID column 604, an instruction execution date column 605, an understanding level column 606, an instruction correspondence column 607, and an associated guideline ID column 608.

The student ID column 601 stores student IDs. The educational material ID column 602 stores educational material IDs 602. The item column 603 stores information showing the units of educational materials. The instructor ID column 604 stores instructor IDs. The instruction execution date column 605 shows, for example, dates when instructions were executed. A date when the content of an instruction was transmitted to the student terminal 300 by the input/output processing section 421 is an example of a date when the instruction was executed. If any instruction has not been executed yet, the instruction execution date column 605 stores, for example, a null value.

The understanding level column 606 shows understanding levels regarding the corresponding units of the corresponding educational material IDs of the corresponding students. The details of understanding levels will be described later. The instruction correspondence column 607 stores instruction correspondences that are given to students by instructors regarding the units of educational materials. Furthermore, for example, the input/output processing section 421 stores instruction correspondences received from the instructor terminal 100 in the instruction correspondence column 607. The associated guideline ID column 608 stores the guideline IDs of guidelines, which satisfy conditions, among guidelines shown by the instruction/intervention guideline table 434.

FIG. 7 shows an example of the intervention request history table 436. The intervention request history table 436 includes, for example, a student ID column 701, an educational material ID column 702, an item column 703, a supporter ID column 704, an instructor ID column 705, an intervention request execution date column 706, an intervention request correspondence column 707, an associated guideline ID column 708, an execution flag column 709, and an intervention execution date column 710.

The student ID column 701 stores student IDs. The educational material ID column 702 stores educational material IDs. The item column 703 stores information showing the units of educational materials. The supporter ID column 704 stores supporter IDs used for identifying supporters. The instructor ID column 705 stores instructor IDs.

The intervention request execution date column 706 shows dates when intervention requests were executed. A date when the input/output processing section 421 transmitted an intervention request to the supporter terminal 200 is an example of a date when the intervention request was executed. If any intervention request has not been executed yet, the intervention request execution date column 706 stores, for example, null values.

The associated guideline ID column 708 stores the guideline IDs of intervention request guidelines, which satisfy conditions, among intervention request guidelines shown by the instruction/intervention guideline table 434. An execution flag is a flag showing whether a requested intervention has been executed or not. For example, if the requested intervention has been executed, the value of the corresponding flag is “1”, and if the requested intervention has not been executed yet, the value of the corresponding flag is “0”.

For example, the initial value of an intervention flag is “0”, and when the input/output processing section 421 receives an intervention notification including a student ID, an educational material ID, an item, and a supporter ID from the supporter terminal 200, the input/output processing section 421 changes the value of the execution flag of the corresponding execution flag column 709 from “0” to “1”. The intervention execution date column 710 shows dates when interventions were executed. A date when the input/output processing section 421 received an intervention notification of the corresponding intervention request is an example of a date when the intervention was executed.

FIG. 8 is a flowchart showing an example of instruction information creation processing and intervention request information creation processing. The server 400 selects records that satisfy the next condition among records the value of the end date column 404 of each of which is not a null value and the value of the type column 407 of each of which is “answer to question” in the learning history table 433 and performs the following processing on the selected records. The condition that should be satisfied by the selected records is records corresponding to the educational material IDs and items of the aforementioned records have not created yet in the instruction history table 435. Hereinafter, these aforementioned records are referred to as processing target records. In addition, a record that is a record that exists in the learning history table 433, shows the same student ID and the same educational material ID of a certain processing target record, and the type of which is “comment reference” is referred to as the processing target comment reference record of the aforementioned certain processing target record.

Furthermore, the following processing is started, for example, by the instructor terminal 100 transmitting the start notification of instruction information/intervention request information creation processing to the server 400 at the time when the instructor terminal 100 is started up or according to an order from an instructor.

First, the understanding level calculation section 422 calculates the understanding level regarding each of the processing target records (at Step 801). To put it concretely, the understanding level calculation section 422 obtains a student ID, an educational material ID, and an item shown by each of the processing target records from the learning history table 433, and stores the obtained the student ID, the obtained educational material ID, and the obtained item in the student ID column 601, the educational material ID column 602, and the item column 603 respectively, and further stores the student ID, the educational material ID, and the item in the student ID column 701, the educational material ID column 702, and the item column 703 respectively.

In addition, the understanding level calculation section 422 obtains a supporter ID corresponding to a student ID included in each of processing target records from the contraction information table 431, and stores the supporter ID in the supporter ID column 704. Next, the understanding level calculation section 422 obtains the rating result of each of processing target records from the learning history table 433, calculates an understanding level corresponding to each obtained rating result, and stores the calculated understanding level in the corresponding cell of the understanding level column 606.

An understanding level is a value representing the understanding state of a student relative to the state of having acquired all the contents to be acquired by learning. The ratio of the total value of rating results relative to the total of allocated points regarding all the questions of a certain unit is an example of an understanding level. In the case of using the aforementioned understanding level, the understanding level calculation section 422 obtains an educational material ID and an allocated point corresponding to a unit shown by each of processing target records from the point allocation column 310 of the point allocation table, and calculates the ratio of rating results relative to the total of allocated points regarding each of the processing target records. In this embodiment, it will be assumed that an understanding level is represented by a value between 0 and 100.

Alternatively, it is also conceivable that the understanding level calculation section 422 calculates a value obtained by substituting the total value of rating results shown by each of respective processing target records in a predefined calculation expression as an understanding level of each of the respective processing target records. Furthermore, it is also conceivable that the memory 420 or the auxiliary storage device 430 holds a table showing the associations between the total values of rating results and understanding levels. In this case, the understanding level calculation section 422 can obtain an understanding level corresponding to the total value of the rating results of each of the processing target records from the aforementioned table as the understanding level regarding each of the aforementioned processing target records.

Next, the activity achievement calculation section 423 calculates activity achievement regarding each of the processing target records (at Step 802). To put it concretely, the activity achievement calculation section 423 calculates an activity achievement necessary for the condition judgment stipulated in the condition column 502 in the learning history table 433 using each of the processing target records and the processing target comment reference record of each of the processing target records. An activity achievement is an index representing the state for a student to have worked on a unit of an educational material. Any of a total of times spent for referring comments and a required time for answering questions is an example of an activity achievement.

In addition, in an example of the condition column 502 shown in FIG. 5, any of “time required for answer” in the conditions of a guideline ID “P0001” and a guideline ID “P0003”, “time required for reference” in the condition of a guideline ID “P1004”, and “uninterrupted” in the condition of the guideline ID “P1004” is an example of an activity achievement.

The activity achievement calculation section 423 obtains a value of the required time column 405 of each of the processing target records as the time required for the answer of each of the processing target records. Furthermore, the activity achievement calculation section 423 obtains the value of the required time column 405 of the processing target comment reference record of each of the processing target records as a comment reference time corresponding to each of the processing target records.

In addition, for example, in the case where the value of the required time column 405 of the processing target comment reference record of each of the processing target records is equal to the difference between the value of the end date column 404 and the value of the start date column 403 of the aforementioned processing target comment reference record, the activity achievement calculation section 423 judges that the comment reference is carried out “uninterrupted”, and in the case where the value of the required time column 405 of the aforementioned processing target comment reference record is not equal to the difference, the activity achievement calculation section 423 judges that the comment reference is carried out “interrupted”.

Next, the instruction/intervention request information creation section 424 creates instruction information for the student and intervention request information for a supporter with reference to the understanding level calculated at Step 801, the activity achievement calculated at Step 802, the instruction/intervention guideline table 434, the instruction history table 435, and the intervention request history table 436 (at Step 803). To put it concretely, first, the instruction/intervention request information creation section 424 judges whether or not each of the processing target records satisfies the corresponding condition stipulated in the condition column 502. The instruction/intervention request information creation section 424 obtains the guideline IDs of processing target records that satisfy the respective conditions and whose styles are “instruction”, and stores the obtained guideline IDs in the associated guideline ID column 608 corresponding to the aforementioned processing target records.

Furthermore, the instruction/intervention request information creation section 424 obtains the guideline IDs of processing target records that satisfy the respective conditions and whose styles are “intervention request”, and stores the obtained guideline IDs in the associated guideline ID column 708 corresponding to the aforementioned processing target records.

Here, if one processing target record satisfies plural conditions, it is conceivable that the instruction/intervention request information creation section 424 obtains, for example, the values of the priority column 505 corresponding to the aforementioned plural conditions, and stores guideline IDs corresponding to a predefined number of conditions, which are selected in the order of the priorities of the aforementioned conditions, in the associated guideline ID column 608 or in the associated guideline ID column 708. Alternatively, if one processing target record satisfies plural conditions, it is conceivable that the instruction/intervention request information creation section 424 obtains the values of the priority column 505 corresponding to the aforementioned plural conditions, and stores guideline IDs of instruction guidelines and guideline IDs of intervention request guidelines in the associated guideline ID column 608 and in the associated guideline ID column 708 respectively in the order of the priorities of the respective guideline IDs.

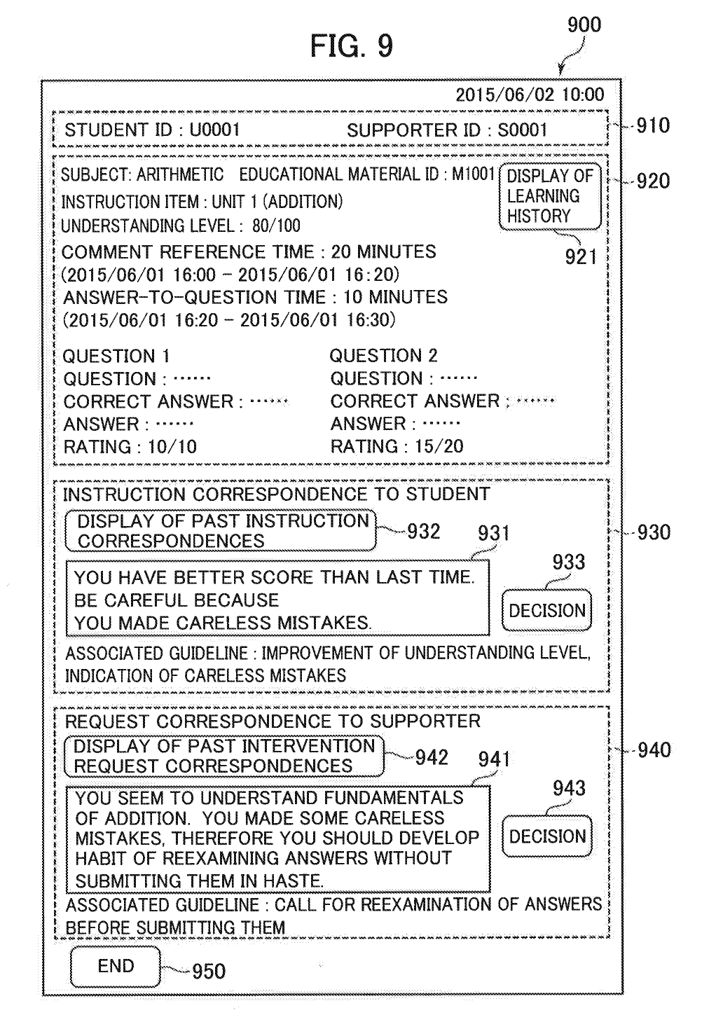

Through the instruction/intervention request information 424 storing the guideline IDs in the order of the priorities of the respective guideline IDs in such a way, the instruction/intervention request information 424 can display the guideline contents corresponding to the aforementioned guideline IDs on a display screen in the aforementioned order, therefore an instructor can easily check important guidelines visually. The detail of the display screen will be described later with reference to FIG. 9. Here, in the case of a second record in an example shown in FIG. 6, a guideline “P0002”, the priority of which is higher than that of the guideline “P0001”, is stored above the guideline “P0001” in rank in the associated guideline ID column 608.

In addition, for example, if there exists a second record of the intervention request history table 436 having a student ID that is the same as the student ID of a first processing target record that satisfies the condition of a first intervention request guideline and a guideline ID corresponding to the first intervention request guideline, the instruction/intervention request information creation section 424 can lower the priority of the guideline ID corresponding the first intervention request guideline when storing the guideline ID in the associated guideline ID column 708. To put it concretely, the instruction/intervention request information creation section 424 can adopt a value obtained by adding a predefined value to the priority of the first intervention request guideline, or can make the value of the priority of the first intervention request guideline larger than any of the values of all other priorities.

Hereinafter, a case example where the instruction/intervention request information creation section 424 judges whether the conditions of the condition column 502 shown in FIG. 5 are respectively satisfied or not will be explained with the first processing target record taken as an example.

In the judgment of the condition of the guideline ID “P0001”, the instruction/intervention request information creation section 424 obtains, for example, the understanding level of a record of the instruction history table 435 that has the same student ID and the same educational material ID as those of the first processing target record and the instruction execution date of which is the latest. The instruction/intervention request information creation section 424 sets the obtained understanding level as the previous understanding level, and through comparing the obtained understanding level with the understanding level of the first processing target record calculated at Step 802, the instruction/intervention request information creation section 424 performs the judgment of the condition “present understanding level>previous understanding level”.

In the judgment of the condition of the guideline ID “P0002”, the instruction/intervention request information creation section 424 judges, for example, that there is a down point due to carelessness if a carelessness flag shown by the first processing target record is “1”, and the instruction/intervention request information creation section 424 judges that there is not a down point due to carelessness if the carelessness flag shown by the first processing target record is “0”.

In the judgment of the condition of the guideline ID “P0003”, the instruction/intervention request information creation section 424 performs judgment processing using, for example, a time required for answer corresponding to the first processing target record that is obtained at Step 803 and the value of the carelessness flag shown by the first processing target record.

In the judgment of the condition of the guideline ID “P1001”, the instruction/intervention request information creation section 424 judges, for example, that “corresponding to previous P0001” holds if there is a record of the instruction history table 435 that has the same student ID and the same educational material ID as those of the first processing target record and includes “P0001” in the associated guideline ID column 608, and judges that “corresponding to previous P0001” does not hold if there is no such a record. A judgment method regarding “present understanding level>previous understanding level” is as described above.

In the judgment of the condition of a guideline ID “P1002”, the instruction/intervention request information creation section 424 judges, for example, whether the understanding level of the first processing target record calculated at Step 802 is smaller than 50 or not. In addition, the instruction/intervention request information creation section 424 specifies a preparatory unit corresponding to the educational material ID and the unit shown by the first processing target record from the educational material information table 432. The instruction/intervention request information creation section 424 judges whether all learnings regarding the specified preparatory unit have been finished or not with reference to the learning history table 433. Here, the instruction/intervention request information creation section 424 can judge that learning regarding the aforementioned preparatory unit has been finished if both “comment reference” and “answer to question” of the preparatory unit have been finished, or can judge that the learning regarding the aforementioned preparatory unit have been finished if at least one of “comment reference” and “answer to question” has been finished.

In the judgment of the condition of a guideline ID “P1003”, the instruction/intervention request information creation section 424, for example, specifies a record having the educational material ID and the unit name shown by the first processing target record from the educational material information table 432, and specifies a question having a preparatory question with reference to the question column 308 of the aforementioned record. The instruction/intervention request information creation section 424 judges that the condition of the guideline ID “P1003” is satisfied with reference to the correct answer column 309 of the specified record and the rating column 410 of the first processing target record if a student answers a question having a preparatory question erroneously and answers the preparatory question of the aforementioned question correctly. Here, a correct answer to a question is, for example, an answer the ratio of the rating result of which to the allocated point of the aforementioned question is equal to or larger than a predefined value. On the other hand, an erroneous answer to a question is, for example, an answer the ratio of the rating result of which to the allocated point of the aforementioned question is smaller than the predefined value. The aforementioned predefined value can be different for different questions.

In the judgment of the condition of the guideline ID “P1004”, the instruction/intervention request information creation section 424, for example, obtains the value of the required time column 405 of a comment reference record corresponding to the first processing target record from the learning history table 433. The instruction/intervention request information creation section 424 judges that the condition of the guideline ID “P1004” is satisfied if the obtained value of the required time column 405 is 30 minutes or more and “uninterrupted” holds regarding the comment reference processing target record of the first processing target record at Step 803.

In the judgment of the condition of a guideline ID “P1005”, for example, if the instruction/intervention request information creation section 424 has judged that “current understanding level>previous understanding level” holds in the judgment of the condition of “P0002”, the instruction/intervention request information creation section 424 obtains a student ID, an educational material ID, and a unit shown by a record in the learning history table 433 corresponding to the understanding level obtained as the previous understanding level. If the intervention execution date shown by a record in the intervention request history table 436 having the obtained student ID, educational material ID, and unit, is included in a predefined time period before a start date shown by the first processing target record, the instruction/intervention request information creation section 424 judges that the condition of the guideline ID “P1005” is satisfied.

Here, in the case where the condition of the guideline ID “P1005” is satisfied, it can be expected that outputting a guideline content that praising a supporter improves the intervention motivation of the supporter.

Let our discussion be back to the explanation of FIG. 8. Lastly, the input/output processing section 421 displays the instruction information and the intervention request information created at Step 803 on the instructor terminal 100 (at Step 804). The detail of the display screen of the instructor terminal 100 will be described later with reference to FIG. 9.

FIG. 9 shows an example of an instructor screen shown on the instructor terminal 100. An instructor decides an instruction correspondence to a student and an intervention request correspondence to a supporter on this screen. In this example shown in FIG. 9, it will be assumed that the instructor screen 900 displays instruction information and intervention request information regarding one unit of one educational material for one student at one time.

The instructor screen 900 includes, for example, a student information display area 910, a learning history information display area 920, an instruction information display area 930, an intervention request information display area 940, and an end button 950. The end button 950 is a button for stopping the display of the instructor screen 900. The student information display area 910 displays, for example, a student ID and a supporter ID. Here, for example, if the contract information table 431 stores a student name and the grade of the student associated with the student ID, and a supporter name and the relationship of the supporter associated with the supporter ID, the student information display area 910 can display these pieces of information.

The learning history information display area 920 displays, for example, a subject, an educational material ID, an item, an understanding level, a required time in a comment reference, the start time and the end time of the comment reference, a required time of an answer to a question, the start time and the end time of the answer to the question, and a question sentence, a correct answer, an answer, and a rating result of each question that are shown in the educational material information table 432, the learning history table 433, or the instruction history table 435. In addition, the learning history information display area 920 can include a learning history display button 921. The display/non-display of the content of the learning history display area can be switched by selecting the learning history display button 921.

The instruction information display area 930 displays, for example, the contents of instruction guidelines that are shown in the instruction/intervention guideline table 434 and corresponding to associated guideline IDs shown in the associated guideline ID column 608 according the priorities of the instruction guideline IDs stored in the associated guideline ID column 608. Furthermore, the instruction information display area 930 includes, for example, an instruction correspondence input area 931, a past instruction correspondence display button 932, and a decision button 933. The instruction correspondence input area 931 receives the input of instruction correspondences.

The past instruction correspondence display button 932 is a button for displaying past instruction correspondences in the instruction information display area 930. Past instruction correspondences are, for example, instruction correspondences given in the past to one student regarding one subject by one instructor. In addition, the instruction information display area 930 can further have an area where a student, a subject, a unit, an instructor, and the like are specified, and it is conceivable that a past instruction sentence satisfying a condition specified in the aforementioned area is displayed in the instruction information display area 930 through the past instruction correspondence display button 932 being selected.

With this, an instructor can input an instruction correspondence with reference to the instruction guideline and the past instruction correspondences that are displayed in the instruction information display area 930. The decision button 933 is a button for storing an instruction correspondence, which is input in the instruction correspondence input area 931, in the instruction history table 435. Furthermore, it is also conceivable that, when the decision button 933 is selected, the input/output processing section 421 transmits the instruction correspondence, the instruction guideline, and the learning history information of the aforementioned student displayed in the learning history information display area 920 to the student terminal 300.

The intervention request information display area 940 displays, for example, the contents of intervention request guidelines that are shown in the instruction/intervention guideline table 434 and corresponding to associated guideline IDs shown in the associated guideline ID column 708 according the priorities of the associated guideline IDs stored in the associated guideline ID column 708. Furthermore, the intervention request information display area 940 includes, for example, an intervention request correspondence input area 941, a past intervention request correspondence display button 942, and a decision button 943. The intervention request correspondence input area 941 receives the input of intervention request correspondences.

The past intervention request correspondence display button 942 is a button for displaying past intervention request correspondences in the intervention request information display area 940. Past intervention request correspondences are, for example, intervention request correspondences given in the past to one student regarding one subject by one instructor. Furthermore, the intervention request information display area 940 can further have an area where a student, a subject, a unit, an instructor, and the like are specified, and it is conceivable that a past intervention request sentence satisfying a condition specified in the aforementioned area is displayed in the intervention request information display area 940 through the past intervention request correspondence display button 942 being selected.

With this, the instructor can input an intervention request correspondence with reference to the intervention request guideline and the past intervention request correspondences that are displayed in the intervention request information display area 940. The decision button 943 is a button for storing an intervention request correspondence, which is input in the intervention request correspondence input area 941, in the intervention request history table 436. Furthermore, it is also conceivable that, when the decision button 943 is selected, the input/output processing section 421 transmits the intervention request correspondence and the intervention request guideline to the supporter terminal 200.

Hereinafter, an example of processing, in which the intervention request information integration processing section 425 integrates intervention requests, and transmits the integrated intervention requests to the supporter terminal 200 into which the input/output processing section 421 is integrated, will be explained. The input/output processing section 421 receives an intervention request direction including a student ID from the instructor terminal 100. The intervention request information integration processing section 425 obtains a record corresponding to an unexecuted intervention request regarding the student ID included in the intervention request direction with reference to the intervention request history table 436.

In the case where the intervention request information integration processing section 425 obtains only one record, the input/output processing section 421 transmits the intervention request shown by the aforementioned record to the supporter terminal 200. The transmitted intervention request includes, for example, an intervention request correspondence shown by the aforementioned record and a guideline content corresponding to an associated guideline ID shown by the aforementioned record.

In the case where the intervention request information integration processing section 425 obtains plural records, the intervention request information integration processing section 425 integrates intervention requests shown by the aforementioned plural records, and the input/output processing section 421 transmits an intervention request, which is obtained after the integration, to the supporter terminal 200. The intervention request obtained after the integration includes intervention request correspondences shown by the aforementioned plural records and guideline contents corresponding to associated guideline IDs shown by the aforementioned plural records. Hereinafter, an example of integration processing will be explained.

The intervention request information integration processing section 425, for example, sorts the guideline contents corresponding to the associated guideline IDs included in the aforementioned plural intervention requests, and includes the sorted guideline contents in the intervention request obtained after the integration. The intervention request information integration processing section 425, executes the aforementioned sorting, for example, according to the priorities of the priority column 505.

In addition, for example, if the intervention request information integration processing section 425 judges that associated guideline IDs, which are the same as the associated guideline IDs included in the aforementioned plural intervention requests, are included in the already-executed intervention requests with reference to the intervention request execution date column 706 and the associated guideline ID column 708, it is conceivable that the intervention request information integration processing section 425 lowers the priorities of guideline contents corresponding to the aforementioned associated guideline IDs in the aforementioned sorting. To put it concretely, the intervention request information integration processing section 425 lowers the priorities of the guideline contents in the aforementioned sorting, for example, by adding predefined numerical values to the priorities of the aforementioned guideline contents.

Through the intervention request information integration processing section 425 executing sorting in the above integration processing as described above, the supporter can recognize important intervention guidelines. Alternatively, it is also conceivable that the intervention request information integration processing section 425 includes, for example, directions that guideline contents the priorities of which are predefined values or larger should be represented in bold or in different colors in the intervention request obtained after the integration or includes only guideline contents the priorities of which are predefined values or larger in the intervention request obtained after the integration instead of executing the aforementioned sorting.

As a different method, it is also conceivable that, in the integration process, for example, if the intervention request information integration processing section 425 judges that there are plural records the values of the associated guideline ID column 708 corresponding to which are the same as the values of the associated guideline ID column corresponding to the aforementioned plural records with reference to the intervention request history table 436, the intervention request information integration processing section 425 merges intervention request correspondences in the intervention request correspondence column 707 corresponding to the aforementioned plural records, and sets an intervention request correspondence obtained after the merger as an intervention request correspondence in an intervention request after the merger.

It is also conceivable that the intervention request information integration processing section 425, for example, randomly selects one representative intervention request correspondence from the aforementioned plural intervention request correspondences, and includes the representative intervention request correspondence in the intervention request after the merger. With this, in the case where a supporter receives intervention requests having the same guidelines in plural units, he/she is prevented from redundantly checking the intervention request correspondences having the same guidelines, with the result that it becomes easy for the supporter to execute interventions.

It often happens that, if a student participates in learning programs of plural units, different instructors for the respective units instruct the student independently. In such a case, the intervention request information integration processing section 425 can integrate intervention requests issued by the plural instructors using the abovementioned processing, with the result that it becomes especially easy for a supporter to execute interventions.

Alternatively, for example, it is also conceivable that the intervention request information integration processing section 425 associates a representative intervention request correspondence with plural intervention request correspondences that are associated with the representative intervention request correspondence, stores the plural intervention request correspondences in the intervention request history table 436, and transmits the aforementioned plural intervention request sentences to the supporter terminal 200 in response to a request from the supporter terminal 200.

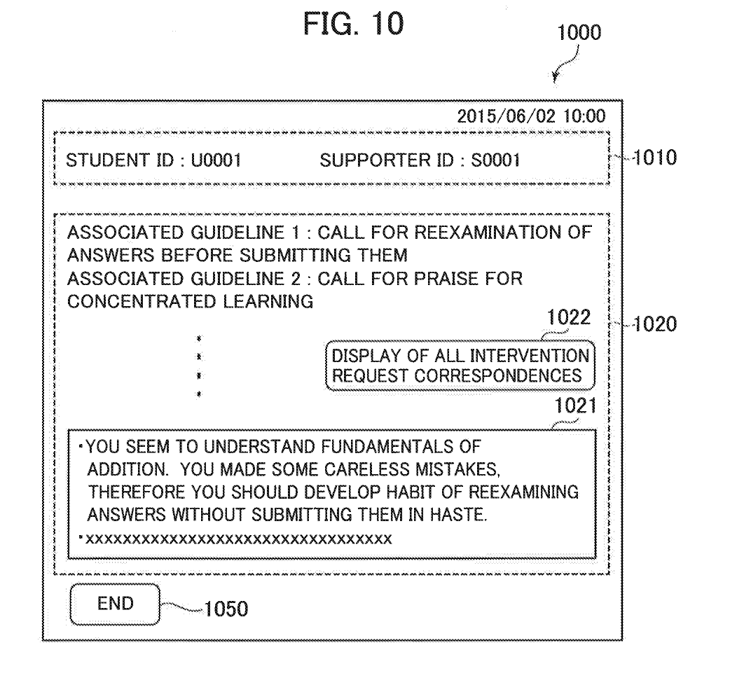

FIG. 10 shows an example of a supporter screen displayed on the supporter terminal 200. The supporter screen 1000 includes, for example, a student information display area 1010, an associated guideline display area 1020, and an end button 1050. The explanations of the student information display area 1010 and the end button 1050 are omitted because they are the same as those of the student information display area 910 and the end button 950.

The associated guideline display area 1020 displays, for example, the guideline contents of the intervention request obtained after the integration, and includes an intervention request correspondence display area 1021 and a button 1022. Here, because the priority of a guideline content “call for reexamination of answers before submitting them” is higher than the priority of a guideline content “call for praise for concentrated learning”, “call for reexamination of answers before submitting them” is displayed above “call for praise for concentrated learning in the associated guideline display area 1020”.

The intervention request correspondence display area 1021 displays intervention request correspondences included in the intervention request obtained after the integration. The button 1022 is a button that, in the case where the intervention request obtained after the integration includes only the representative request correspondence, obtains all intervention request correspondences corresponding to the aforementioned representative request correspondence from the server 400, and displays them.

As described above, the learning program support system according to this embodiment can create information for putting the instruction of an instructor and the intervention of a supporter into practice in such a way that the instruction and the intervention cooperate with each other in accordance with a learning history, an instruction history, an intervention request history, and the like. Furthermore, through the instruction and the intervention, which conform to the information created by the learning program support system, put into practice, the motivation for the self-learning of a student can be sustained or improved, and therefore it becomes possible to lower the risk that the student might interrupt a learning program in which he/she is participating.

In addition, the present invention is not limited to the above embodiment, and the present invention may include various kinds of modification examples. For example, the above embodiment has been described in detail for the purpose of explaining the present invention in an easily understood manner, therefore the present invention is not always required to include all the configurations described in the above embodiment. Furthermore, a part of the configuration of one embodiment can be replaced with a part of the configuration of another embodiment, and it is also possible to add the configuration of one embodiment to the configuration of another embodiment. In addition, a new embodiment of the present invention may be made by adding another configuration to a part of the configuration of each embodiment, by deleting a part of the configuration from each embodiment, or by replacing a part of configuration of each embodiment with another configuration.

Furthermore, the all or some of the above configurations, functions, processing sections, processing means, and the like can be realized by hardware manufactured by, for example, integrated circuits. Alternatively, the above configurations, functions, and the like can be realized by software in such a way that a processor interprets programs that realizes the functions of the respective configurations and the like, and executes the programs. Information that is included in the programs, tables, and files and that is used for realizing the above functions can be stored in storage devices such as a memory, a hard disk, an SSD (a solid state drive) and the like, or in recording media such as an IC card, an SD card, a DVD, and the like.

In addition, in the above-described drawings, control lines and information lines are shown in the case where they are indispensable for explaining the above embodiments, therefore all control lines and information lines required for implementing the above embodiments are not necessarily shown. It is conceivable that in reality almost all components in almost every embodiment are interconnected.

1. A learning program provision system for providing a student with a learning program including a plurality of units, the learning program provision system comprising:
a processor and a storage device;
wherein the storage device stores:
learning history information that shows a learning history including at least one of an understanding level and an activity achievement for each of the plurality of units of the student;
instruction guideline information that shows the relationship between a condition based on at least one of the understanding level and the activity achievement and an instruction guideline including guidelines for instructions executed to the student by an instructor in charge of the learning program; and
intervention guideline information that shows the relationship between a condition based on at least one of the understanding level and the activity achievement and an intervention guideline including guidelines for interventions executed to the student by a supporter who supports the learning of the student and who is not the instructor, and
the processor:
obtains a learning history corresponding to each of the plurality of units shown by the learning history information;
compares the obtained learning history regarding each of the plurality of units and a condition regarding each of the plurality of units shown by the instruction guideline information with each other, and obtains instruction guidelines corresponding to satisfied conditions from the instruction guideline information;
outputs the obtained instruction guidelines to the student terminal used by the student;
compares the obtained learning history regarding each of the plurality of units and a condition regarding each of the plurality of units shown by the intervention guideline information with each other, and obtains intervention guidelines corresponding to satisfied conditions from the intervention guideline information; and
outputs the obtained intervention guidelines to a student terminal used by the student.

2. The learning program provision system according to claim 1,
wherein the processor:
determines the display methods of the obtained intervention guidelines on the basis of predefined priorities; and
outputs the obtained intervention guidelines and the determined display methods to the supporter terminal.

3. The learning program provision system according to claim 2,
wherein the storage device stores intervention guideline history information that shows the intervention guidelines that have already been output to the supporter terminal, and
the processor lowers the priorities of intervention guidelines included in the intervention guideline history information among the obtained intervention guidelines according to a predefined condition in the determination of the display methods.

4. The learning program provision system according to claim 1,
wherein the processor:
receives the inputs of intervention request correspondences corresponding to the respective obtained intervention guidelines; and
in the case where intervention guidelines corresponding to each of the units of a unit group included in the plurality units includes a first intervention guideline,
outputs a first intervention request correspondence included in an intervention request correspondence corresponding to the first intervention guideline of each of the units of the unit group to the supporter terminal.

5. The learning program provision system according to claim 1,
wherein the learning history information shows a time required for the student to answer the question of each of the plurality of units and the presence or absence of a down point regarding the question of each of the plurality of units due to the carelessness of the student,
the intervention guideline information includes a first condition that a time required for the student to answer a question of a unit is within a predefined time and there is a down point regarding the aforementioned question of the unit due to the carelessness of the student, and
an intervention guideline corresponding to the first condition in the intervention guideline information proposes that the supporter should call to the student to reexamine an answer to a question before submitting the answer.

6. The learning program provision system according to claim 1,
wherein the learning history information shows a time required for the student to refer to a comment regarding each of the plurality of units and whether or not the student interrupted referring to the comment regarding each of the plurality of units;
the intervention guideline information includes a second condition that a time required for the student to refer to a unit is a predefined time or longer and the student did not interrupt referring to the aforementioned unit; and
an intervention guideline corresponding to the second condition in the intervention guideline information proposes that the supporter should praise the student for his/her concentration into learning.

7. The learning program provision system according to claim 1,
wherein the intervention guideline includes guidelines for interventions executed to the supporter by the instructor,
the storage device further stores:
understanding level history information showing the history of understanding levels of the student; and
intervention history information showing the history of interventions executed by the supporter,
the learning history includes an understanding level of the student for each of the plurality of units,
the intervention guideline information includes a third condition that the understanding level shown by the learning history information is higher than the corresponding understanding level shown by the understanding level history information, and the corresponding intervention is executed by the supporter, and
an intervention guideline corresponding to the third condition in the intervention guideline information proposes that the instructor should praise the supporter for the advantageous effect of the intervention executed by the supporter, and
the processor:
obtains the intervention history of the supporter from the intervention history information; and
compares the obtained learning history and intervention history regarding each of the plurality of units with a condition regarding each of the plurality of units shown by the intervention guideline information, and obtains intervention guidelines corresponding to satisfied conditions from the intervention guideline information.

8. A learning program provision method in which a learning program provision system provides a student with a learning program including a plurality of units,
wherein the learning program provision system stores:
learning history information that shows a learning history including at least one of an understanding level and an activity achievement for each of the plurality of units of the student;
instruction guideline information that shows the relationship between a condition based on at least one of the understanding level and the activity achievement and an instruction guideline including guidelines for instructions executed to the student by an instructor in charge of the learning program; and
intervention guideline information that shows the relationship between a condition based on at least one of the understanding level and the activity achievement and an intervention guideline including guidelines for interventions executed to the student by a supporter who supports the learning of the student and who is not the instructor, and
the learning program provision system further:
obtains a learning history corresponding to each of the plurality of units shown by the learning history information;
compares the obtained learning history regarding each of the plurality of units and a condition regarding each of the plurality of units shown by the instruction guideline information with each other, and obtains instruction guidelines corresponding to satisfied conditions from the instruction guideline information;
outputs the obtained instruction guidelines to a student terminal used by the student;
compares the obtained learning history regarding each of the plurality of units and a condition regarding each of the plurality of units shown by the intervention guideline information with each other, and obtains intervention guidelines corresponding to satisfied conditions from the intervention guideline information; and
outputs the obtained intervention guidelines to the student terminal used by the student.

9. The learning program provision method according to claim 8,
wherein the learning program provision system:
determines the display methods of the obtained intervention guidelines on the basis of predefined priorities; and
outputs the obtained intervention guidelines and the determined display methods to the supporter terminal.

10. The learning program provision method according to claim 9,
wherein the learning program provision system stores intervention guideline history information that shows the intervention guidelines that have already been output to the supporter terminal; and
in the learning program provision method, the learning program provision system further lowers the priorities of intervention guidelines included in the intervention guideline history information among the obtained intervention guidelines according to a predefined condition in the determination of the display methods.

11. The learning program provision method according to claim 8,
wherein the learning program provision system:
receives the inputs of intervention request correspondences corresponding to the respective obtained intervention guidelines; and
in the case where intervention guidelines corresponding to each of the units of a unit group included in the plurality units includes a first intervention guideline,
outputs a first intervention request correspondence included in an intervention request correspondence corresponding to the first intervention guideline of each of the units of the unit group to the supporter terminal.

12. The learning program provision method according to claim 8,
wherein the learning history information shows a time required for the student to answer the question of each of the plurality of units and the presence or absence of a down point regarding the question of each of the plurality of units due to the carelessness of the student,
the intervention guideline information includes a first condition that a time required for the student to answer a question of a unit is within a predefined time and there is a down point regarding the aforementioned question of the unit due to the carelessness of the student, and
an intervention guideline corresponding to the first condition in the intervention guideline information proposes that the supporter should call to the student to reexamine an answer to a question before submitting the answer.

13. The learning program provision method according to claim 8,
wherein the learning history information shows a time required for the student to refer to a comment regarding each of the plurality of units and whether or not the student interrupted referring to the comment regarding each of the plurality of units;
the intervention guideline information includes a second condition that a time required for the student to refer to a unit is a predefined time or longer and the student did not interrupt referring to the aforementioned unit; and
an intervention guideline corresponding to the second condition in the intervention guideline information proposes that the supporter should praise the student for his/her concentration into learning.

14. The learning program provision method according to claim 8,
wherein the intervention guideline includes guidelines for interventions executed to the supporter by the instructor,
the learning program provision system further stores:
understanding level history information showing the history of understanding levels of the student; and
intervention history information showing the history of interventions executed by the supporter,
the learning history includes an understanding level of the student for each of the plurality of units,
the intervention guideline information includes a third condition that the understanding level shown by the learning history information is higher than the corresponding understanding level shown by the understanding level history information, and the corresponding intervention is executed by the supporter, and
an intervention guideline corresponding to the third condition in the intervention guideline information proposes that the instructor should praise the supporter for the advantageous effect of the intervention executed by the supporter, and
the learning program provision system further:
obtains the intervention history of the supporter from the intervention history information; and
compares the obtained learning history and intervention history regarding each of the plurality of units with a condition regarding each of the plurality of units shown by the intervention guideline information, and obtains intervention guidelines corresponding to satisfied conditions from the intervention guideline information.
